(19) United States
(12) Patent Application Publication
(10) Pub. No.: US 2024/0421574 A1
(43) Pub. Date: Dec. 19, 2024

(54) DECORATIVE PANEL

(71) Applicant: EARTHQI DESIGN CO., LTD., Taipei City (TW)

(72) Inventor: Po-Wen Yang, Taipei City (TW)

(21) Appl. No.: 18/735,118

(22) Filed: Jun. 5, 2024

(51) Int. Cl. H02G 3/14; H01H 9/02

(52) U.S. Cl. CPC H02G 3/14; H01H 9/02

(57) ABSTRACT

The present invention relates to a decorative panel designed for assembly on an outlet or a switch unit. The outlet includes multiple body slots, and the decorative panel comprises multiple slot reserved holes, each corresponding to one of the body slots. The surface of the decorative panel is seamless and flat. This decorative panel easily integrates into various interior design styles, offering an aesthetic solution that combines functionality with modern decor preferences.

### FIELD OF THE DISCLOSURE

The present invention relates to a decorative panel, specifically to a decorative panel that has a seamless and flat surface.

### BACKGROUND OF THE INVENTION

Outlets are types of electrical devices used to connect electrical appliances to a power source. Outlets typically consist of a base, a plug, pins, and fuses. Outlets can be categorized into residential, industrial, and specialty types, each differing in shape, current capacity, and environmental application. Among these, residential outlets are the most common and are typically installed on walls to connect household electrical devices such as televisions, computers, refrigerators, air conditioners, and washing machines.

Referring to FIGS. 1A through 1C, FIG. 1A illustrates a conventional outlet 10, FIG. 1B shows the body 12 of the outlet, and FIG. 1C depicts the housing panel 11. The housing panel 11 includes a rectangular perforation 11H into which the central rectangular section 12A of the outlet body 12 is fitted and adapted.

As modern aesthetics and interior design become increasingly important, every detail must be carefully considered. However, at the interface 11J between the central rectangular section 12A and the rectangular perforation 11H, a level difference can create a perceptible seam that detracts from the overall aesthetic appeal of the environment. This junction, being prone to accumulating dust and dirt, can make cleaning more challenging.

Accordingly, there is a need in the art to address these issues and provide an improved solution that can seamlessly integrate with interior decor while simplifying maintenance.

### SUMMARY OF THE INVENTION

The present invention aims to provide a decorative panel that easily integrates into various interior design styles, featuring a surface that is clean, sleek, and less prone to accumulating dust and dirt, thereby facilitating easier cleaning.

The decorative panel of the invention is designed for assembly on an outlet, which includes multiple body slots. The panel itself comprises multiple reserved holes, each corresponding to one of the body slots, ensuring a seamless and flat surface appearance.

The edges of the decorative panel include frames that encircle the outlet, contributing to a design that lacks visible division lines or locking points. Additionally, the panel incorporates a reinforcement structure that rests against the upper surface of the outlet, enhancing its durability and structural integrity.

Another embodiment of the invention involves a decorative panel designed for assembly on a switch unit that includes multiple buttons. This panel features a button reserved hole for each button, maintaining the seamless and flat surface characteristic. Like the version designed for outlets, this panel's edges include frames that surround the switch unit, with no division lines or locking points, and it includes a similar reinforcement structure abutting the upper surface of the switch unit.

The decorative panels can be manufactured from materials such as plastic, metal, glass, or ceramic, each chosen for their durability and aesthetic compatibility with various interior designs.

The advantages of the present invention include its ability to blend seamlessly into various interior decors and its ease of cleaning, offering both aesthetic appeal and practical functionality.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1A illustrates a schematic view of a conventional outlet 10.

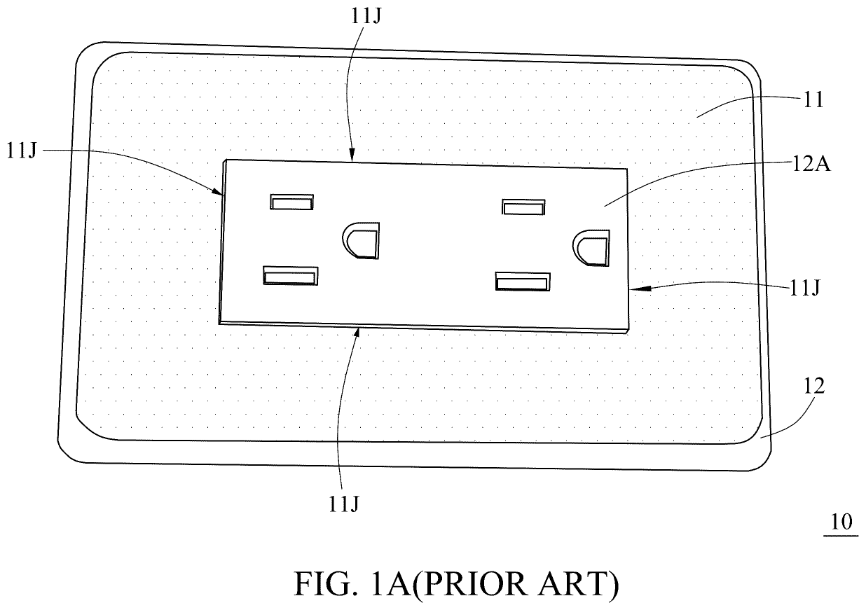

FIG. 1B shows a schematic diagram of the body portion 12 of the outlet.

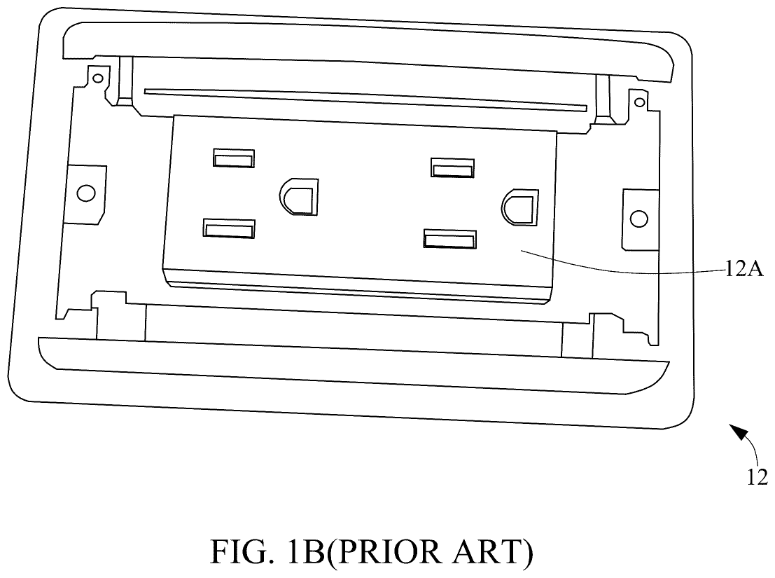

FIG. 1C depicts a schematic diagram of the housing panel 11.

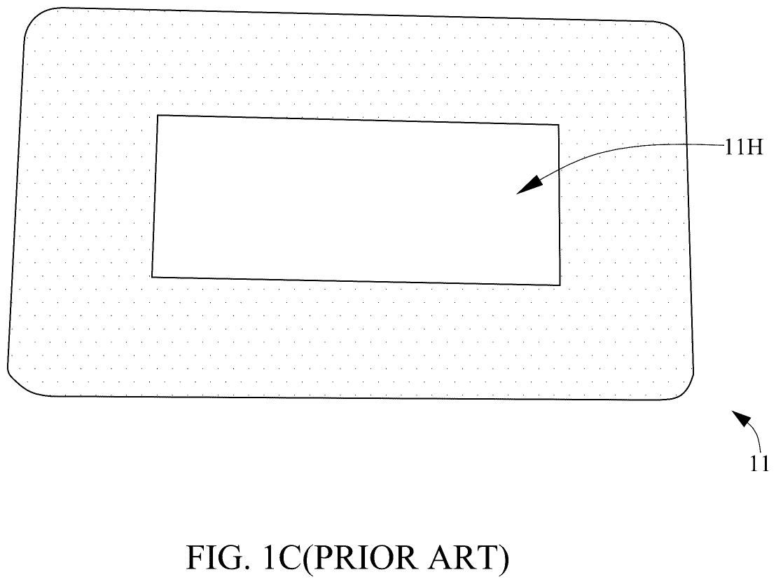

FIG. 2A illustrates a perspective view of a decorative panel 21 for an outlet, shown from various angles.

FIG. 2B shows a perspective view of the outlet 22.

FIG. 2C illustrates a schematic diagram of the decorative panel 21 assembled on the outlet 22.

FIG. 3A illustrates a perspective view of another embodiment of the decorative panel 31.

FIG. 3B shows a perspective view of the outlet 32.

FIG. 3C illustrates a schematic diagram of the decorative panel 31 assembled on the outlet 32.

FIG. 4A illustrates a perspective view of the decorative panel 41.

FIG. 4B shows a perspective view of the switch unit 42.

FIG. 4C illustrates a schematic diagram of the decorative panel 41 assembled on the switch unit 42.

FIG. 4D illustrates a perspective view of the decorative panel 41 from another angle.

### DESCRIPTION OF THE PREFERRED EMBODIMENTS

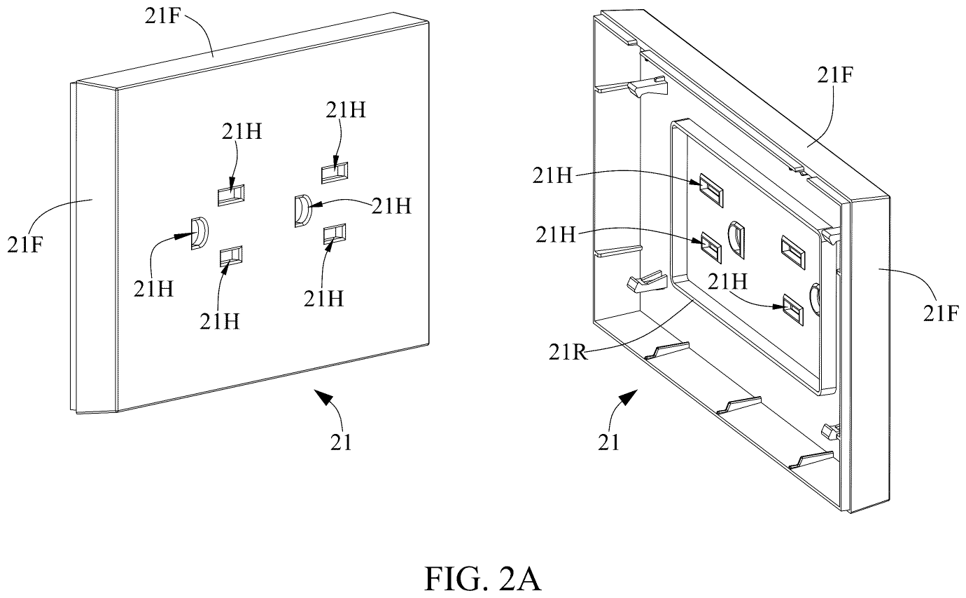

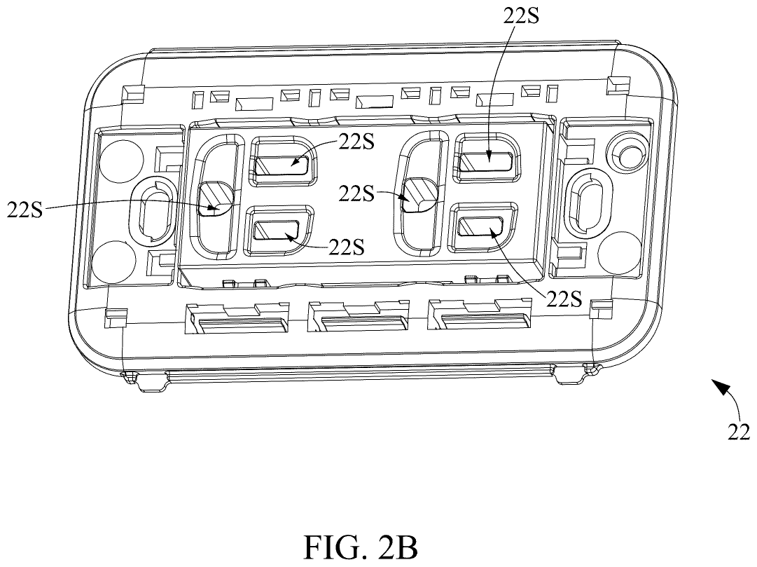

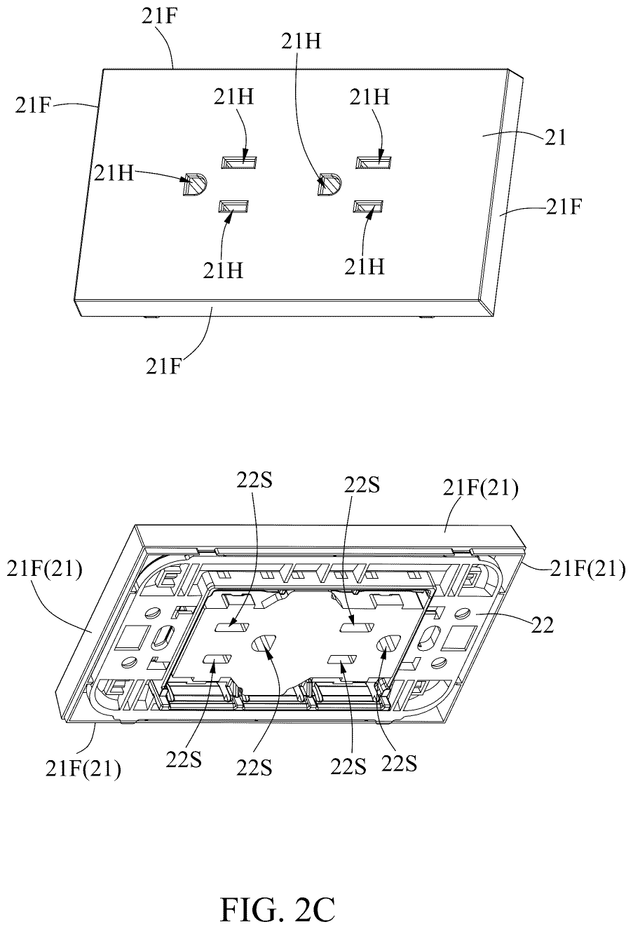

Referring to FIGS. 2A to 2C, FIG. 2A illustrates a perspective view of the decorative panel 21 from various angles, FIG. 2B shows a perspective view of the outlet 22, and FIG. 2C depicts the decorative panel 21 as assembled on the outlet 22.

In this embodiment, the decorative panel 21 is assembled onto an outlet 22, which includes multiple body slots designated as 22S. These body slots 22S serve as interfaces for providing electrical connections, allowing external) electrical devices to be powered by inserting plugs into the body slots 22S.

The decorative panel 21 comprises multiple slot reserved holes 21H and a reinforcement structure 21R. Each slot reserved hole 21H corresponds specifically to one body slot 22S, allowing plugs to pass through and connect for power acquisition.

The decorative panel 21 can be made from materials such as plastic, metal, glass, or ceramic. Predominantly, these panels are fabricated from plastics like flame-resistant ABS due to their cost-effectiveness and ease of manufacture. Additionally, the surface of the decorative panel 21 may undergo electroplating processes to enhance its overall texture.

Furthermore, high-end decorative panels may utilize metals such as copper and stainless steel, which offer enhanced durability and corrosion resistance. Some design-centric panels are made from glass, known for its aesthetic appeal and excellent heat resistance. Additionally, ceramic materials are used for some panels due to their superior fire resistance and insulation properties.

In this embodiment, the surface of the decorative panel 21 is seamless and flat, covering the outlet 22 almost entirely except for the slot reserved holes 21H. This design is considerably smoother compared to the conventional outlet 10, adding a refined look to interior decor. The simple yet modern appearance of the decorative panel 21 seamlessly blends with various interior decoration styles, enhancing the aesthetic and fashionable appeal of the space. It not only meets daily usage requirements but also enriches the home decor experience for the user.

Moreover, because the surface texture and pores of the decorative panel 21 are finely detailed and lack the level differences found at junction 11J of the conventional outlet 10, the panel is less prone to accumulating dust and dirt, minimizes visible scratches, and is easier to clean and maintain. The detailed surface texture and pore design also provide a more comfortable user experience, delivering superior tactile feedback.

Referring again to FIG. 2C, the reinforcement structure 21R is located on the side of the decorative panel 21 facing the outlet 22, and it surrounds the reserved holes 21H. In this embodiment, the reinforcement structure 21R abuts the upper surface of the outlet 22. This arrangement effectively enhances the overall strength of the decorative panel 21. Moreover, when subjected to external forces, the decorative panel 21 is less likely to deform or sustain damage, significantly increasing its durability and protective capabilities.

Additionally, the four edges of the decorative panel 21 each include a frame 21F, which encircles the outlet 22. The top surface of the decorative panel 21 and each frame 21F feature a matte texture design. It is noteworthy that maintaining the same matte texture on all five surfaces is challenging. This is because as the density of the matte material increases, the particles become larger, which can lead to particle damage during demolding, a phenomenon known as “drag marks.” Therefore, numerous prototyping attempts are required to ensure that all five surfaces maintain the same matte pattern.

Furthermore, the primary purpose of the frames 21F is to beautify and protect the outlet 22 within the wall, making the decorative panel 21 more neat and visually appealing. Additionally, the four frames 21F provide a certain level of safety protection, helping to prevent electrical shocks or short circuits.

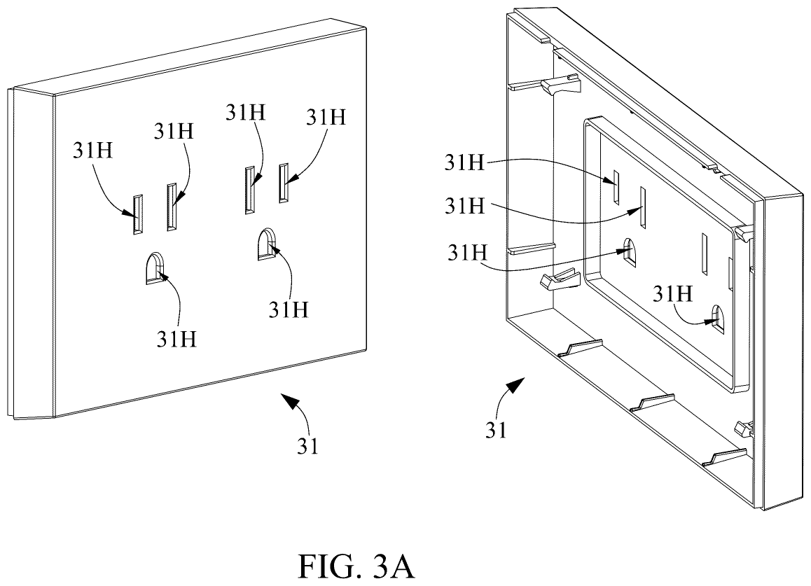

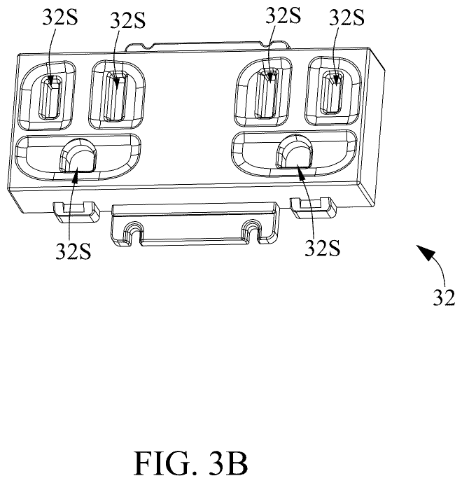

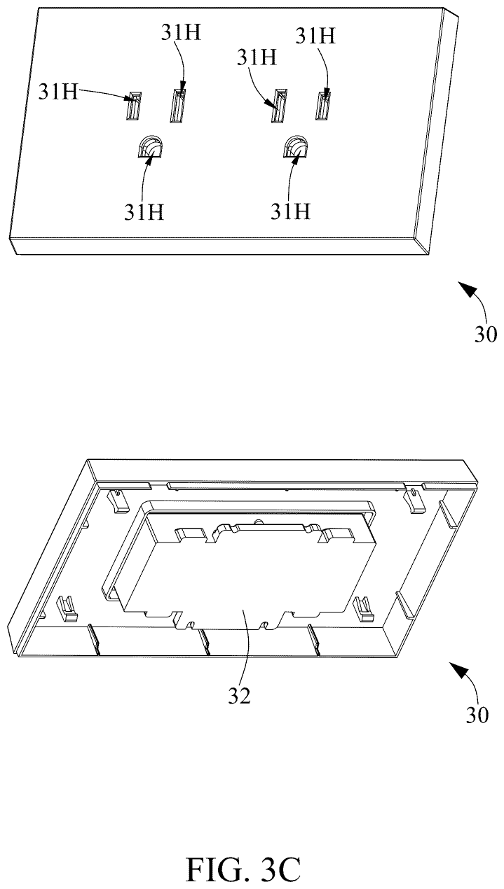

Referring to FIGS. 3A to 3C, FIG. 3A illustrates a perspective view of another embodiment of the decorative panel 31, FIG. 3B shows a perspective view of the outlet 32, and FIG. 3C depicts the decorative panel 31 as assembled on the outlet 32.

The decorative panel 31 is similarly assembled on an outlet 32, which includes multiple body slots 32S serving as interfaces for electrical connections. The decorative panel 31 also features multiple slot reserved holes 31H, each corresponding to one of the body slots 32S. Additionally, the surface of the decorative panel 31 is seamless and flat. Thus, the decorative panel 31 easily integrates into various interior design styles and is easy to clean.

The difference between the decorative panels 31 and 21 lies in the arrangement of the slot reserved holes 31H. The arrangement of the three slot reserved holes 31H in decorative panel 31 differs from that in decorative panel 21, which may prevent plugs designed for use with decorative panel 31 from being inserted into decorative panel 21, and vice versa. The designs of decorative panels 31 and 21 are intended to meet different needs and application scenarios, thus, the choice between using decorative panel 31 or 21 should be based on the plug type or its physical configuration.

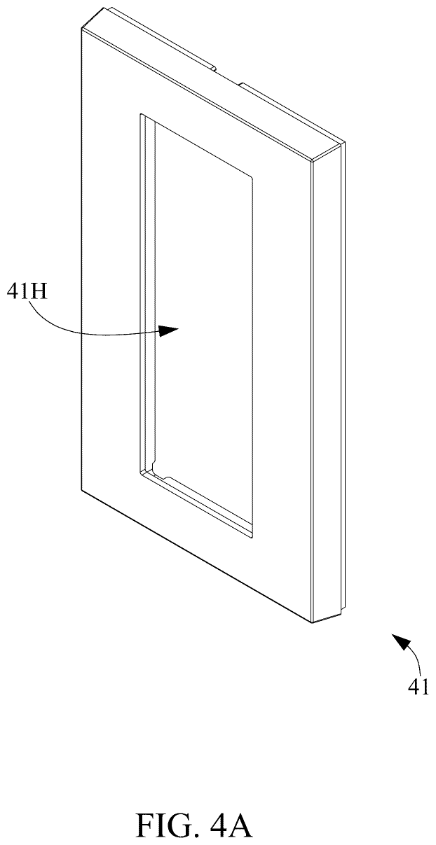

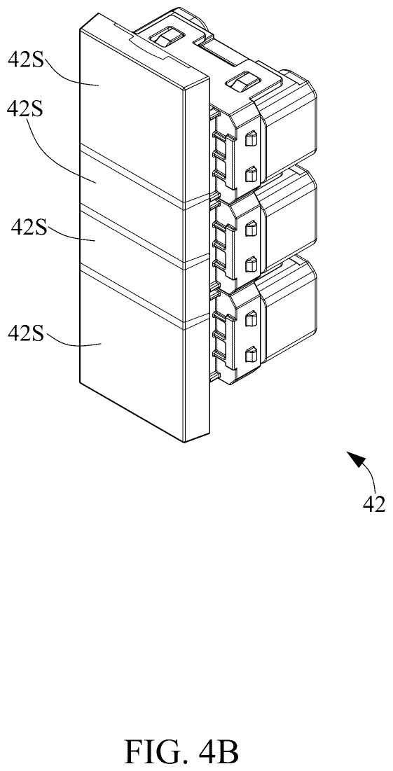

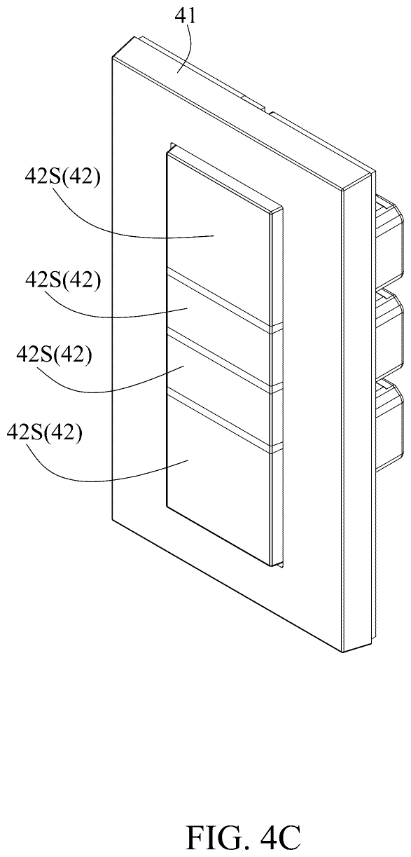

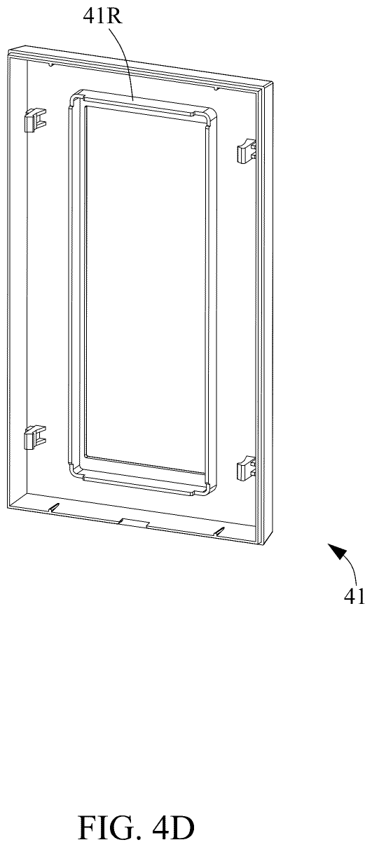

Referring to FIGS. 4A to 4C, FIG. 4A illustrates a perspective view of the decorative panel 41, FIG. 4B shows a perspective view of the switch unit 42, and FIG. 4C depicts the decorative panel 41 as assembled on the switch unit 42. While the decorative panels 21 and 31 are primarily applied to outlets 22 and 32, respectively, in other embodiments, decorative panels are also applicable to switches. The following details an embodiment applied to switches: the decorative panel 41 is assembled onto the switch unit 42, which includes multiple buttons 42S, and the decorative panel 41 features a button reserved hole 41H and a reinforcement structure 41R. The button reserved hole 41H corresponds to these buttons 42S. More specifically, the overall cross-sectional area of the buttons 42S closely matches the cross-sectional area of the button reserved hole 41H. Moreover, the buttons 42S are designed with aesthetic and functional considerations to ensure a sleeker appearance and enhanced tactile feedback when pressed.

It is worth noting that the surface of the decorative panel 41 is also smooth and seamless. Therefore, the decorative panel 41 can easily integrate into various interior decoration styles and is also convenient to clean.

Referring to FIG. 4D, which illustrates a perspective view of the decorative panel 41 from another angle, the reinforcement structure 41R is located on the side of the decorative panel 41 that faces the switch unit 42, and it abuts the upper surface of the switch unit 42. This configuration ensures that the decorative panel 41 is not prone to denting or damage, significantly enhancing its durability and protective capabilities.

In summary, the decorative panels of the present invention seamlessly blend into various interior decoration styles and their surfaces are less likely to accumulate dust and dirt, making them easier to clean. The transformation of complexity into a simple, sleek, and delicate design represents a unique product not available in the market, further benefiting interior designers in their work.

1. A decorative panel for assembly on an outlet, the outlet comprising multiple body slots, the decorative panel comprising:
multiple reserved holes, each reserved hole respectively corresponding to one of the body slots; and
a reinforcement structure abutting the upper surface of the outlet;
wherein the surface of the decorative panel is seamless and flat.

2. The decorative panel of claim 1, wherein the four peripheries of the decorative panel each include a frame, said frames surrounding the outlet, and wherein the surface of the decorative panel is devoid of any division lines or locking points.

3. The decorative panel of claim 1, wherein the material of the decorative panel is selected from the group consisting of plastic, metal, glass, and ceramic.

4. A decorative panel for assembly on a switch unit, the switch unit comprising multiple buttons, the decorative panel comprising:
a button reserved hole, the button reserved hole corresponding to said buttons;
wherein the surface of the decorative panel is seamless and flat.

5. The decorative panel of claim 4, wherein the four peripheries of the decorative panel each include a frame, said frames surrounding the switch unit, and wherein the surface of the decorative panel is devoid of any division lines or locking points.

6. The decorative panel of claim 4, further comprising a reinforcement structure abutting the upper surface of the switch unit.

7. The decorative panel of claim 4, wherein the material of the decorative panel is selected from the group consisting of plastic, metal, glass, and ceramic.
